(19) United States
(12) Patent Application Publication
(10) Pub. No.: US 2026/0283897 A1
(43) Pub. Date: Sep. 24, 2026

(54) PENILE STIMULATION DEVICE

(71) Applicant: Dongguan Mimao Electronic Technology Co., Ltd., Dongguan (CN)

(72) Inventors: Qinling WANG, Heyuan (CN); Yinyuan LI, Dongguan (CN)

(21) Appl. No.: 19/571,546

(22) Filed: Mar. 19, 2026

(30) Foreign Application Priority Data
Mar. 19, 2025 (CN) 202520493076.6

(51) Int. Cl. A61H 19/00

(52) U.S. Cl. CPC A61H 19/32; A61H 2201/0153; A61H 2201/1215; A61H 2201/14; A61H 2201/1654; A61H 2201/1671; A61H 2201/1692

(57) ABSTRACT

A penile stimulation device includes a mounting portion, a massage portion and a driving assembly, the mounting portion includes a rigid housing, the housing defines a mounting chamber, the mounting portion has a first end and a second end opposite to the first end along a first axis; the massage portion extends obliquely relative to the first axis, the massage portion has a connecting end movably connected to the first end of the mounting portion and an open end having an opening facing away from the mounting portion, the massage portion defines a massage space in communication with the opening for accommodating a penis; and the driving assembly includes a motor and a gearbox received within the mounting chamber of the housing of the mounting portion; and wherein the motor is configured to drive the massage portion to rotate around the first axis via the gearbox.

### CROSS-REFERENCE TO RELATED APPLICATIONS

This application claims priority of Chinese Utility Model Application No. 202520493076.6, filed on Mar. 19, 2025. The contents of which are incorporated herein by reference.

### TECHNICAL FIELD

The present disclosure relates to the technical field of adult products, and in particular to a penile stimulation device.

### BACKGROUND

In recent years, sexual stimulation devices have been developed to help users to release their sex pressure. Typical sexual stimulation devices, such as masturbators, just use vibration motors to provide high-frequency vibrations to the users' sensitive areas, such as the male genitalia and the like. The traditional sexual stimulation devices have monotonous stimulation effects and are therefore unable to satisfy users' needs.

### SUMMARY

An object of the present disclosure is to provide a penile stimulation device with a better stimulation effect to improve the users' sexual experience.

In order to achieve the above object, according to a first aspect, the present disclosure provides a penile stimulation device, the penile stimulation device including:

a mounting portion, comprising a rigid housing, the rigid housing defining a mounting chamber, the mounting portion having a first end and a second end opposite to the first end along a first axis;

a massage portion, made of a soft material, extending obliquely relative to the first axis, the massage portion having a connecting end movably connected to the first end of the mounting portion and an open end having an opening facing away from the mounting portion, the massage portion defining a massage space in communication with the opening for accommodating a penis; and

a driving assembly, comprising a motor and a gearbox received within the mounting chamber of the rigid housing of the mounting portion; and wherein the motor is configured to drive the massage portion to rotate around the first axis via the gearbox.

Embodiments of the present disclosure further provide another penile stimulation device, including:

a mounting portion, comprising a rigid housing, the rigid housing defining a mounting chamber, the mounting portion having a first end and a second end opposite to the first end along a first axis;

a massage portion, made of a soft material, having a connecting end movably connected to the first end of the mounting portion and an open end having an opening, the massage portion defining a massage space in communication with the opening for receiving a penis, and the massage space having a second axis extending obliquely relative to the first axis; and

a driving assembly, comprising a motor and a gearbox received within the mounting chamber of the rigid housing of the mounting portion; and

wherein the motor is configured to drive the massage portion to rotate around the first axis via the gearbox.

Compared with the prior art, the embodiments of the present disclosure provide a penile massage device, the drive assembly of the penile massage device, through its motor and gearbox, is capable of driving the massage portion to rotate. After the user inserts the penis into the massage space, the massage portion in turn drives the penis to rotate, thereby continuously changing the position and force angle of the penis during the massage process, achieving a dynamic three-dimensional stimulation for the penis. Simultaneously, during the rotating motion, the massage portion also scrapes circumferentially against the skin surface of the penis, thereby generating sliding friction stimulation. The above dual stimulation function contributes to enhancing the massage effect and improving the user experience.

### BRIEF DESCRIPTION OF THE DRAWINGS

In order to illustrate the technical solution in embodiments of the present disclosure more clearly, the following briefly introduces accompanying drawings used in the description of the embodiments. Apparently, the accompanying drawings in the following description are only some embodiments of the present disclosure. Those of ordinary skill in the art can obtain other accompanying drawings from these accompanying drawings without any creative efforts.

FIG. 1 is a schematic structural view of a penile stimulation device according to an embodiment of the present disclosure.

FIG. 2 is a schematic structural view of the penile stimulation device illustrated in FIG. 1 at another viewpoint.

FIG. 3 is a schematic structural view of the penile stimulation device illustrated in FIG. 1 at yet another viewpoint.

FIG. 4 is a sectional schematic view of the penile stimulation device illustrated in FIG. 3, taken along a line A-A.

FIG. 5 is an exploded view of the penile stimulation device illustrated in FIG. 1.

FIG. 6 is a schematic structural view of a penile stimulation device according to another embodiment of the present disclosure.

FIG. 7 is a schematic structural view of the penile stimulation device illustrated in FIG. 6 at another viewpoint.

FIG. 8 is a sectional schematic view of the penile stimulation device illustrated in FIG. 7, taken along a line B-B.

FIG. 9 is an exploded view of the penile stimulation device illustrated in FIG. 6.

FIG. 10 is a schematic structural view of a penile stimulation device according to yet another embodiment of the present disclosure.

FIG. 11 is a schematic structural view of the penile stimulation device illustrated in FIG. 10 at another viewpoint.

FIG. 12 is a sectional schematic view of the penile stimulation device illustrated in FIG. 11, taken along a line C-C.

FIG. 13 is a sectional schematic view of the penile stimulation device illustrated in FIG. 11, taken along a line D-D.

FIG. 14 is a sectional schematic view of the penile stimulation device illustrated in FIG. 11, taken along a line E-E.

FIG. 15 is an exploded view of the penile stimulation device illustrated in FIG. 10.

### LIST OF REFERENCE SIGNS

Penile stimulation device 100; mounting portion 1; housing 11; mounting chamber 111; second soft member 12; first mounting hole 13; first end 14; second end 15; massage portion 2; massage space 21; circumferential wall 211; bottom wall 212; connecting sleeve 23; massage body 24; insertion end 241; closed end 242; massage sleeve 243; opening 25; rib 26; bumps 27; connecting end 28; open end 29; first axis L1; second axis L2; driving assembly 3; motor 31; gearbox 32; output shaft 321; transmission shaft 33; first shaft segment 331; second shaft segment 332; first mounting groove 333; flange 334; support member 34; second mounting hole 341; second mounting groove 342; bearing 35; vibration member 4; circuit board 5; energy storage member 6.

### DESCRIPTION OF THE EMBODIMENTS

In order to make those skilled in the art better understand the technical solution of the present disclosure, the technical solution in the embodiments of the present disclosure will be clearly and completely described below with reference to accompanying drawings in the embodiments of the present disclosure. Apparently, the described embodiments are merely a part of the embodiments of the present disclosure, but not all of the embodiments. Based on the embodiments of the present disclosure, all other embodiments obtained by those skilled in the art without any creative efforts fall within the protection scope of the present disclosure.

It should be noted that when an element is said to be "connected" to another element, it may be directly connected to another element, or indirectly connected to another element through one or multiple intermediate elements.

In the specification, the oriental or positional relationships indicated by the terms “lateral”, “longitudinal”, “transverse”, “top”, “bottom”, “inner”, “outer”, “central”, “axial”, “radial”, “circumferential”, “vertical” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

Unless otherwise specified and limited, the specific meanings of all technical and scientific terms used in the specification can be specifically understood by persons of ordinary skill in the art. The terms used in the specification of this disclosure are for the purpose of describing specific embodiments only and are not intended to limit this disclosure.

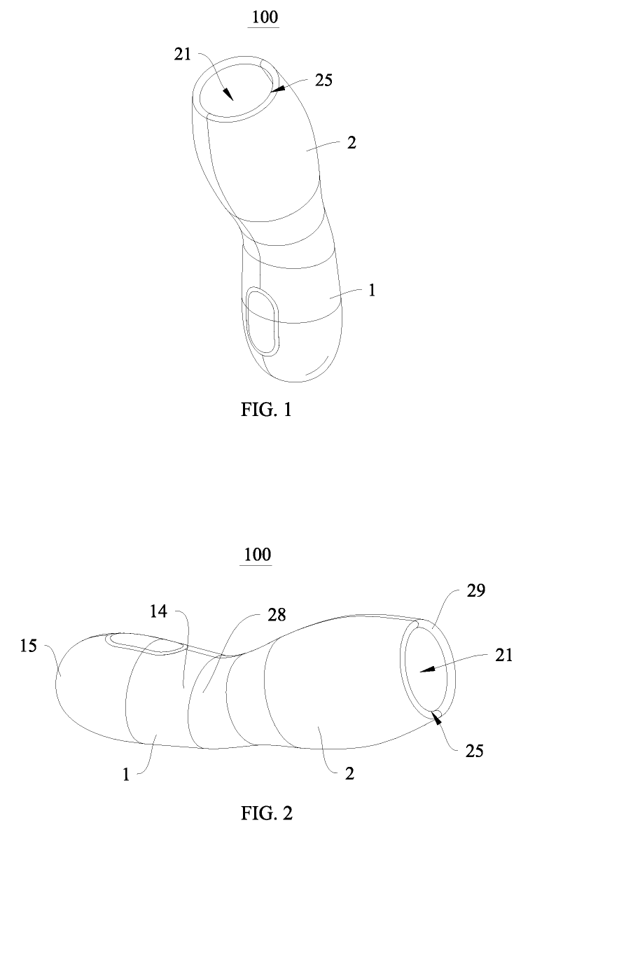

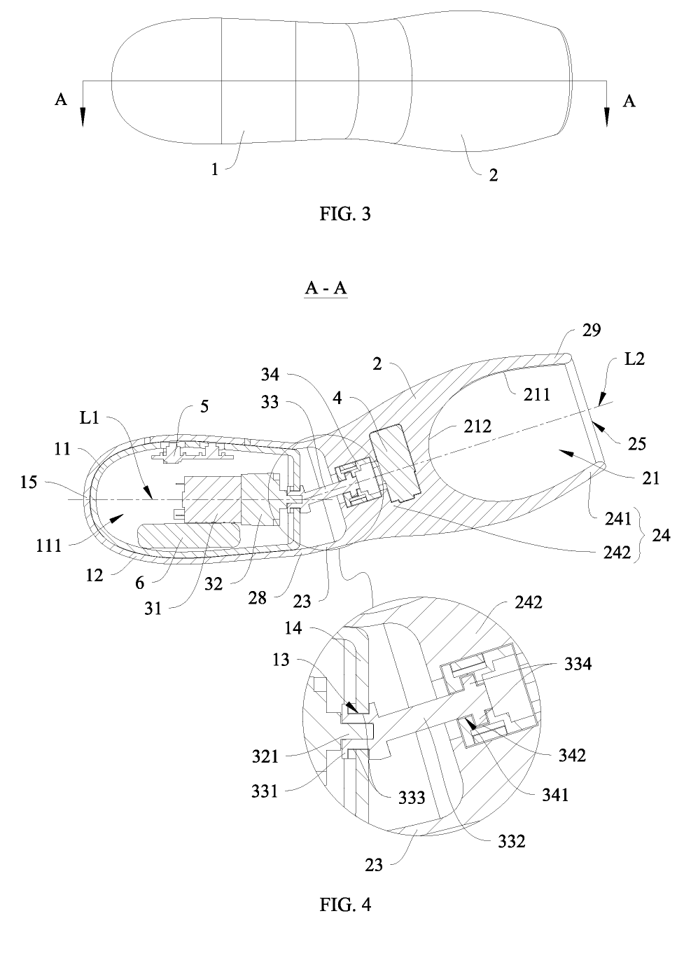

Please refer to FIGS. 1-5, the present disclosure provides a penile stimulation device 100, which is specifically a handheld massage device that is lightweight, compact, easy to operate and use, and also convenient for storage and carrying.

By way of example, the penile stimulation device 100 includes a mounting portion 1 having a first axis L1, a massage portion 2, and a driving assembly 3. The massage portion 2 is movably connected to an end of the mounting portion 1 along the first axis L1 and extends obliquely relative to the first axis L1. The massage portion 2 defines a massage space 21 for insertion of a penis. The driving assembly 3 includes a motor 31 and a gearbox 32 received within the mounting portion 1. The motor 31 is configured to drive the massage portion 2 to rotate about the first axis L1 via the gearbox 32.

Specifically, the motor 31 is in transmission connection with the gearbox 32. After the power output from the motor 31 is reduced in speed and increased in torque by the gearbox 32, an output shaft 321 of the gearbox 32 can drive the massage portion 2 to rotate about the first axis L1. In particular, as the massage portion 2 extends obliquely relative to the first axis L1, the massage portion 2 rotates, or also referred to as revolves, around the first axis L1. Preferably, the massage portion 2 rotates continuously in a single direction along a circle centered on the first axis L1.

Alternatively, the rotation of the massage portion 2 may be reciprocating back and forth along an arc centered on the first axis L1. In that case, the massage portion 2 rotates alternately in opposite directions to reciprocate back and forth.

Consequently, after a user inserts the penis into the massage space 21, the massage portion 2 can drive the penis to perform the aforementioned rotation, thereby continuously changing the position and force angle of the penis during the massage process, achieving dynamic three-dimensional stimulation of the penis. Simultaneously, during the rotating motion, the massage portion 2 also scrapes circumferentially against the skin surface of the penis, thereby generating sliding friction stimulation. This dual stimulation function contributes to enhancing the massage effect and improving the user experience.

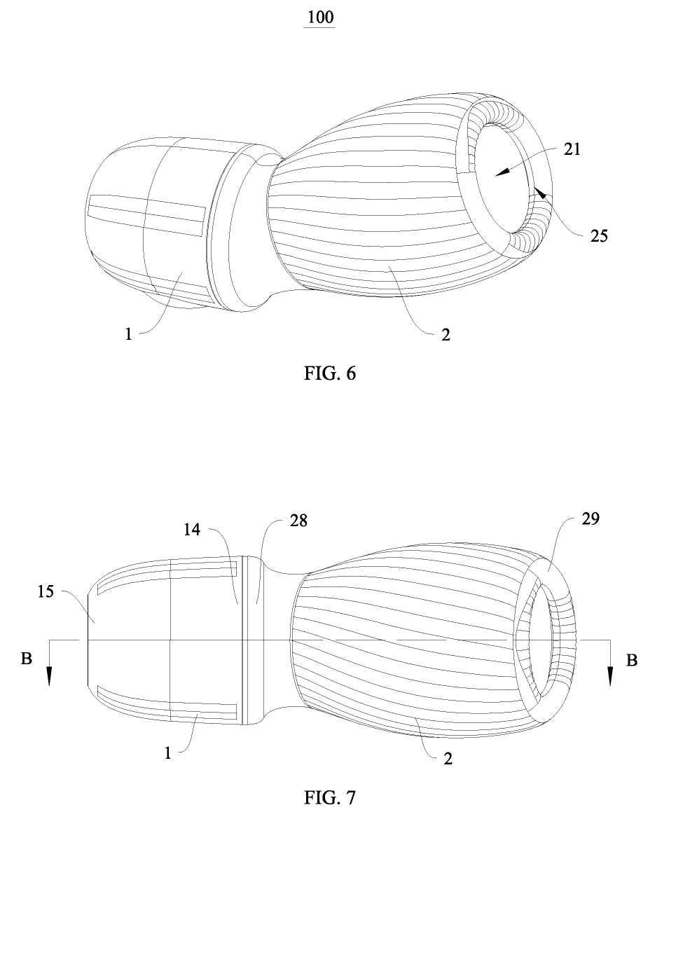

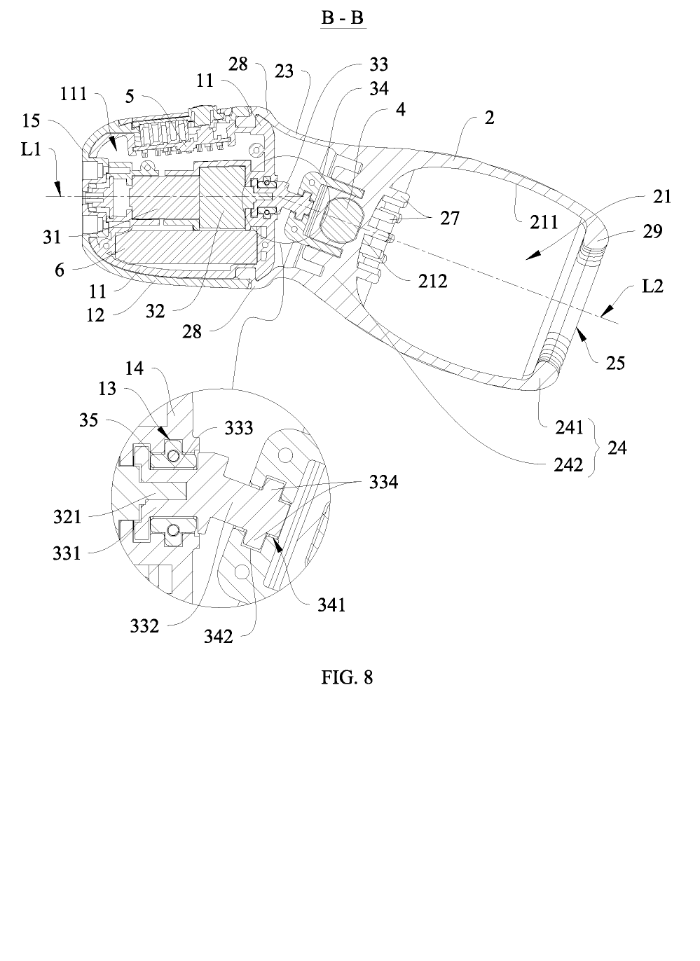

In one embodiment, please refer to FIGS. 6-8. The mounting portion 1 includes a rigid housing 11. The housing 11 defines a mounting chamber 111, in which the motor 31 and the gearbox 32 are received. The massage portion 2 is a first soft member connected to the housing 11. Specifically, the first soft member is fixedly connected to the housing 11 at an end along the first axis L1. The first soft member and the housing 11 form an interference fit via form-fit connection. In other embodiments, the first soft member may also be fixed to the housing 11 by means such as snap-fit connection, threaded connection or adhesive bonding.

In one embodiment, the housing 11 includes, but is not limited to, rigid plastics such as polypropylene (PP), polyvinyl chloride (PVC), and polycarbonate (PC), thereby providing sufficient strength of structural support for the internal components received therein and also allowing the user to grip it during use.

In one embodiment, the first soft member includes, but is not limited to, silicone that is non-toxic, antibacterial, and has good chemical stability. Using soft, skin-friendly materials can improve the users’ experience.

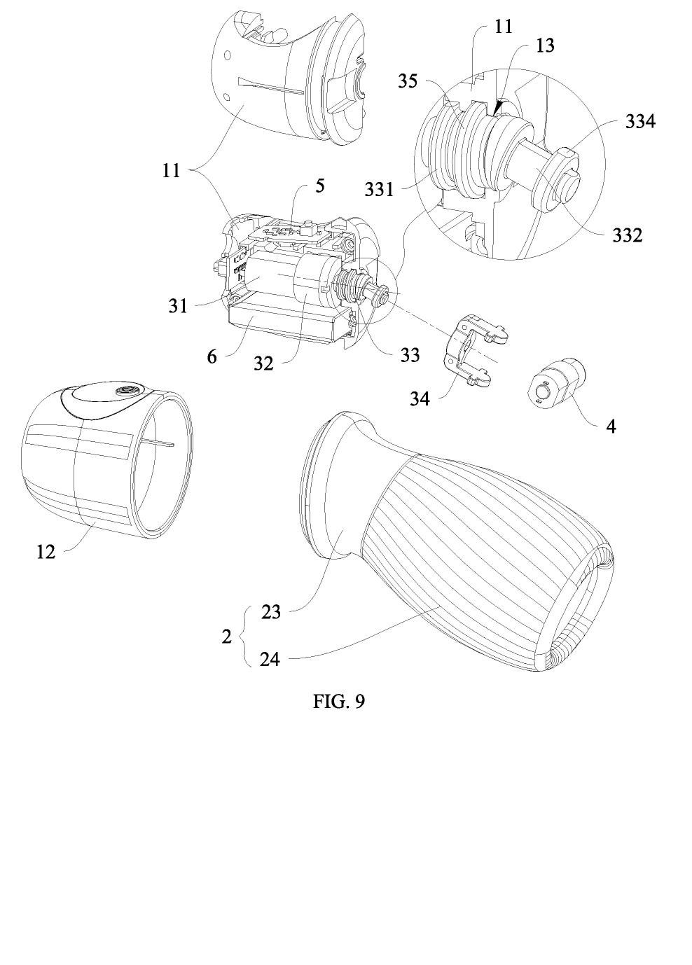

In one embodiment, please refer to FIGS. 8-9. The mounting portion 1 includes a second soft member 12 covering an exterior of the housing 11. The second soft member 12 can improve the grip comfort of the mounting portion 1. In this embodiment, one end of the second soft member 12 and one end of the first soft member form an interference fit via elastic contact.

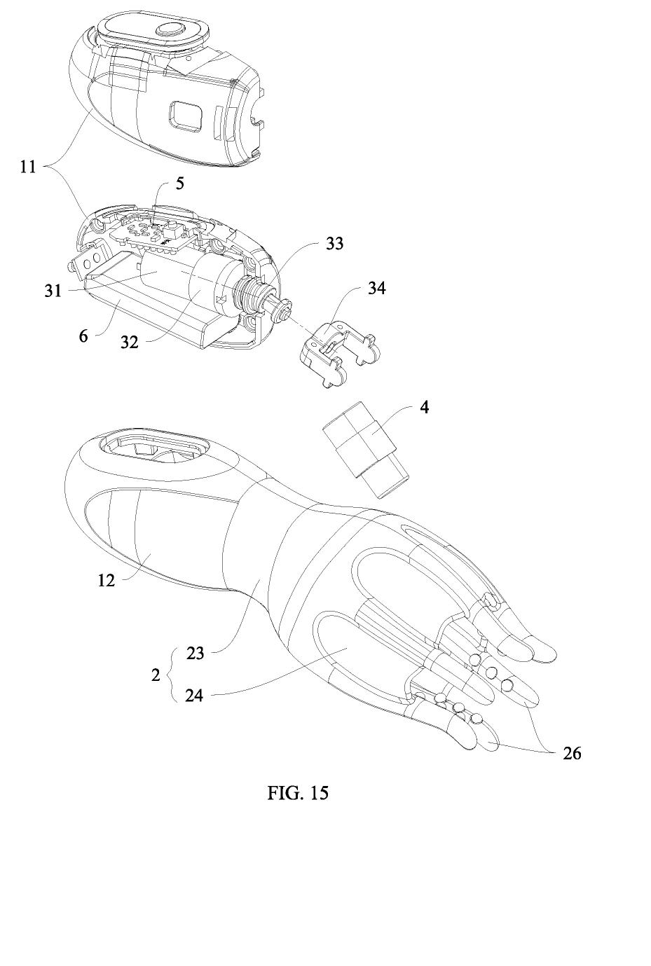

In the embodiments shown in FIGS. 4-5 and 12-15, the first soft member and the second soft member 12 are integrally formed as a one-piece structure, i.e. the first soft member and the second soft member 12 are undividable and undetachable. The first soft member is connected to the housing 11 via the second soft member 12, thereby further enhancing the overall aesthetics and sealing of the product. Additionally, the second soft member 12 may also be made of silicone to improve the users’ experience.

In some embodiments, please refer to FIGS. 4, 8, and 12, the mounting portion 1 has a first end 14 and a second end 15 opposite to the first end 14 along a first axis L1. The massage portion 2 has a connecting end 28 movably connected to the first end 14 of the mounting portion 1, and an open end 29 provided with an opening 25. The opening 25 is in communication with the massage space 21 and is facing away from the mounting portion 1. Specifically, the opening 25 is substantially circular, allowing the penis to insert into the massage space 21 through the opening 25. In other embodiments, the opening 25 may also be designed in a shape corresponding to the contour of the penis to improve the user experience.

In the aforementioned embodiments, the massage portion 2 includes a hollow connecting sleeve 23 and a massage body 24 that defines the massage space 21 therein. The massage body 24 is cylindrical and includes an insertion end 241, and a closed end 242 located opposite the insertion end 241. The insertion end 241 serves as the open end 29 of the massage portion 2 and is provided with the opening 25. One end of the connecting sleeve 23 is connected to the closed end 242 of the massage body 24, and the other end of the connecting sleeve 23 serves as the connecting end 28 of the massage portion 2 and is connected to the mounting portion 1, so that the massage body 24 is mounted on the mounting portion 1 via the connecting sleeve 23. Preferably, the connecting sleeve 23 and the massage body 24 are integrally formed as a one-piece structure so as to form the massage portion 2, i.e., the first soft member.

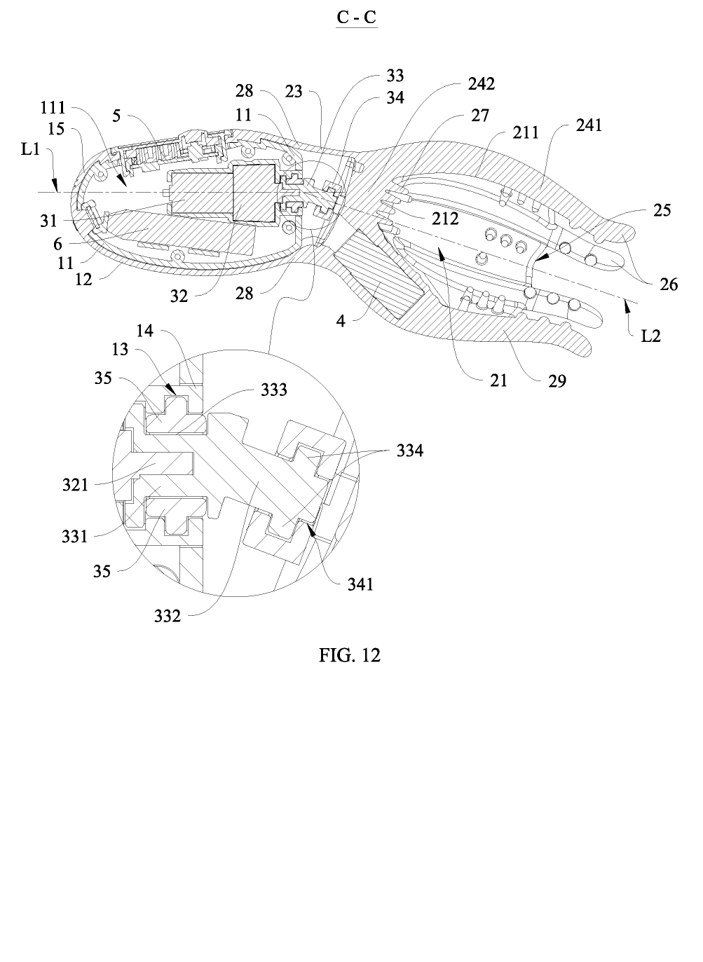

Specifically, in the embodiment shown in FIG. 8, one end of the connecting sleeve 23 is fixedly connected to the housing 11 at an end along the first axis L1. In the embodiments shown in FIGS. 4 and 12, one end of the connecting sleeve 23 is connected to the second soft member 12 at an end along the first axis L1 and integrally formed with the second soft member 12 as a one-piece structure.

In a preferred embodiment, the connecting sleeve 23 is designed as a thin-walled structure, and its wall thickness is less than that of the massage body 24. When the driving assembly 3 drives the massage portion 2 to rotate about the first axis L1, the thin-walled structure of the connecting sleeve 23 is more conducive to the deformation during rotation. This design effectively concentrates and releases stress at the connecting sleeve 23, avoiding fatigue damage to the massage body 24 due to repeated deformation, thereby enhancing the structural reliability and service life of the massage portion 2 and ensuring the device remains functional after long-term use.

In a preferred embodiment, the connecting sleeve 23 is narrowed and configured as a waist. In a radial direction perpendicular to the extension direction (i.e., the first axis L1) between the first end 14 and the second end 15 of the mounting portion 1, a radial dimension of the connecting sleeve 23 is smaller than a radial dimension of the mounting portion 1. In a radial direction perpendicular to the extension direction between the connecting end 28 and the open end 29 of the massage portion 2, the radial dimension of the connecting sleeve 23 is smaller than a radial dimension of the massage body 24.

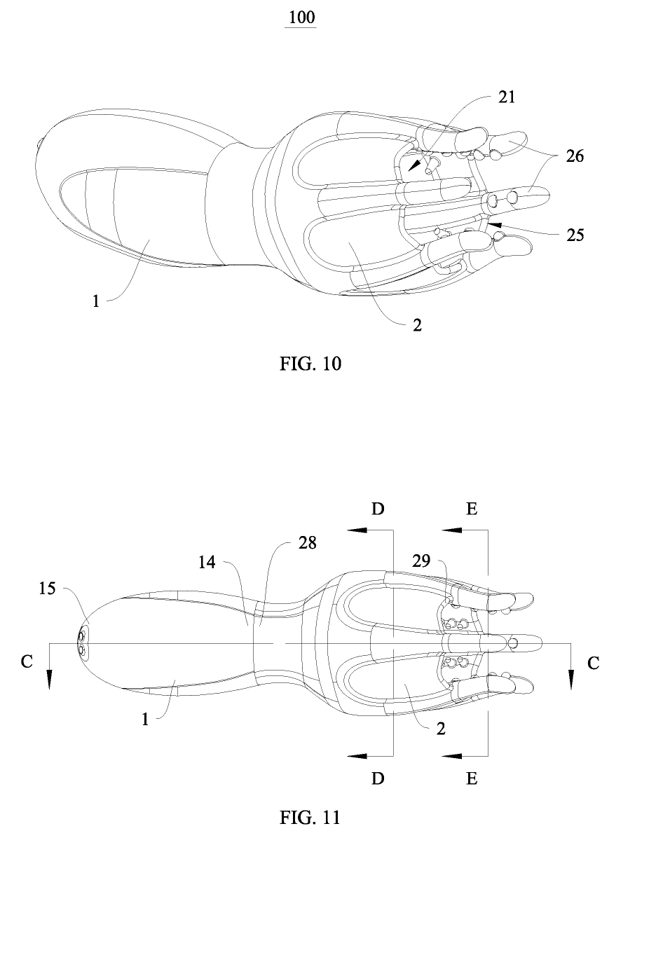

In one embodiment, please refer to FIGS. 10-15, the massage body 24 includes a massage sleeve 243 and a plurality of ribs 26. The massage sleeve 243 is cylindrical and defines the massage space 21 and the opening 25. The plurality of ribs 26 are arranged spaced apart from each other along a circumferential wall of the massage sleeve 243. Each of the plurality of ribs 26 extends along an extending direction of the massage sleeve 243. In the illustrated embodiment, the plurality of ribs 26 are soft structures integrally formed with the massage sleeve 243 as a one-piece structure.

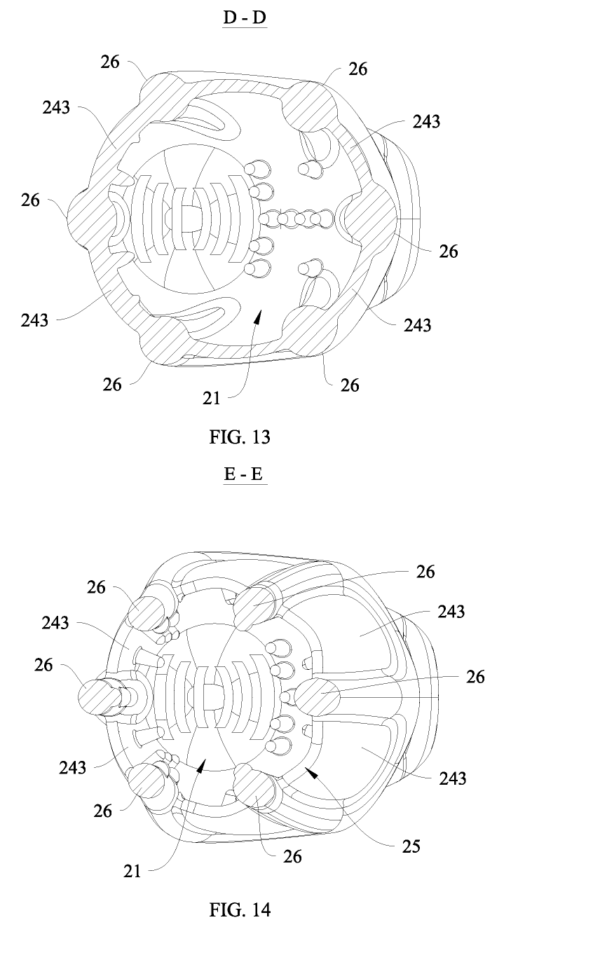

Preferably, referring to FIG. 13, the plurality of ribs 26 protrude from at least one of an inner surface and an outer surface of the circumferential wall of the massage sleeve 243. These ribs 26 can directly contact the penis in the massage space 21 during massage, thereby providing auxiliary support, and enhancing tactile sensation.

Preferably, referring to FIG. 14, the plurality of ribs 26 extend outward from an end of the massage sleeve 243 at which the opening 25 is defined. Preferably, each of the plurality of ribs 26 extends beyond the massage sleeve 243 from an end of the massage sleeve 243 at which the opening 25 is defined to form a free end, and wherein the free ends of the plurality of ribs 26 are arranged in a configuration of claw, which helps improve the sense of envelopment and overall massage experience.

In some embodiments, please refer to FIGS. 4, 8, and 12, a surface of the massage portion 2 that defines the massage space 21 is configured as a curved surface to improve the fit and sense of envelopment when contacting the penis. In the illustrated embodiments, the massage space 21 is substantially a cylindrical cavity. The cylindrical cavity has a second axis L2 which extends substantially along the insertion direction of the penis. The cylindrical cavity includes a circumferential wall 211 configured as a curved surface. In some embodiments, the cylindrical cavity further includes a bottom wall 212 distal to the opening 25, and the bottom wall 212 is also configured as a curved surface. In such embodiments, the circumferential wall 211 and the bottom wall 212 are both configured as curved surfaces. Preferably, the circumferential wall 211 and the bottom wall 212 are connected via a smooth rounded transition to form a continuous, smooth inner surface profile of the cylindrical cavity.

Preferably, in some embodiments, a maximum radial dimension of the cylindrical cavity is less than 60 mm. In other embodiments, a length of the cylindrical cavity along the second axis L2 is in a range of 20 mm to 120 mm. In yet other embodiments, an inclination angle of the second axis L2 of the cylindrical cavity relative to the first axis L1 is in the range of 5° to 45°.

In some embodiments, the surface of the massage portion 2 that defines the massage space 21 is provided with a plurality of granular bumps 27. Preferably, for example, in the embodiment shown in FIG. 8, the plurality of granular bumps 27 are arranged in a spaced manner on the bottom wall 212 of the cylindrical cavity. For another example, in the embodiment shown in FIG. 12, the bottom wall 212 and the circumferential wall 211 of the cylindrical cavity are both arranged with a plurality of granular bumps 27. In this embodiment, each rib 26 is also provided with a plurality of granular bumps 27. These bumps 27 can increase friction between the surface of the massage space 21 and the penis, thereby enhancing the stimulation effect.

In some embodiments, please refer to FIGS. 4, 8, and 12, the driving assembly 3 includes a transmission shaft 33. One end of the transmission shaft 33 is connected to the output shaft 321 of the gearbox 32. The other end of the transmission shaft 33 extends into the massage portion 2 and is in transmission connection with the massage portion 2. At least a portion of the transmission shaft 33 is inclined relative to the first axis L1.

Specifically, the output shaft 321 of the gearbox 32 extends along the first axis L1. After the power output from the motor 31 is reduced in speed and increased in torque by the gearbox 32, the output shaft 321 drives the transmission shaft 33 to rotate about the first axis L1. Since at least a portion of the transmission shaft 33 is inclined relative to the first axis L1, the inclined portion of the transmission shaft 33 will move along a conical trajectory when rotating about the first axis L1. This inclined portion extends into the massage body 24, thereby driving the massage portion 2 to perform the corresponding rotating motion.

In the aforementioned embodiments, the transmission shaft 33 includes a first shaft segment 331 and a second shaft segment 332 connected to one end of the first shaft segment 331. The first shaft segment 331 extends along the first axis L1. The second shaft segment 332 is inclined relative to the first axis L1. An end of the first shaft segment 331 away from the second shaft segment 332 is connected to the output shaft 321 of the gearbox 32. An end of the second shaft segment 332 away from the first shaft segment 331 is connected to the massage body 24. Swinging or rotating of the second shaft segment 332 about the first axis L1 drives the massage body 24 to rotate about the first axis L1, and the trajectory of the massage body 24 is substantially a conical surface about the first axis L1. In other embodiments, the transmission shaft 33 may also be an inclined shaft that is connected at one end to the output shaft 321 and is entirely inclined and extends relative to the first axis L1.

In some embodiments, please refer to FIGS. 4-5, 8-9, 12, and 15, the driving assembly 3 includes a support member 34 arranged within the massage portion 2. The support member 34 is made of a rigid material such as rigid plastics. An end of the transmission shaft 33 away from the gearbox 32 is rotatably engaged with the support member 34. In the illustrated embodiments, an end of the second shaft segment 332 away from the first shaft segment 331 is rotatably connected to the support member 34. The support member 34 is disposed within the closed end 242 of the massage body 24. On one hand, the support member 34 provides additional structural support for the massage body 24, and on the other hand, it can reduce direct sliding friction between the second shaft segment 332 and the soft massage body 24 during rotation, thereby reducing internal wear of the massage body 24 caused by friction during long-term use.

In some embodiments, please refer to FIGS. 4-5, 8-9, 12, and 15, the mounting portion 1 is provided with a first mounting hole 13, preferably disposed on the housing 11. The first shaft segment 331 passes through the first mounting hole 13. The first shaft segment 331 and the first mounting hole 13 are rotatably engaged about the first axis L1 and are fixedly engaged in a direction along the first axis L1. Consequently, the first shaft segment 331 can rotate about the first axis L1 relative to the mounting portion 1, and the first mounting hole 13 can provide an axial limiting function for the first shaft segment 331, preventing it from accidentally sliding out axially during rotation.

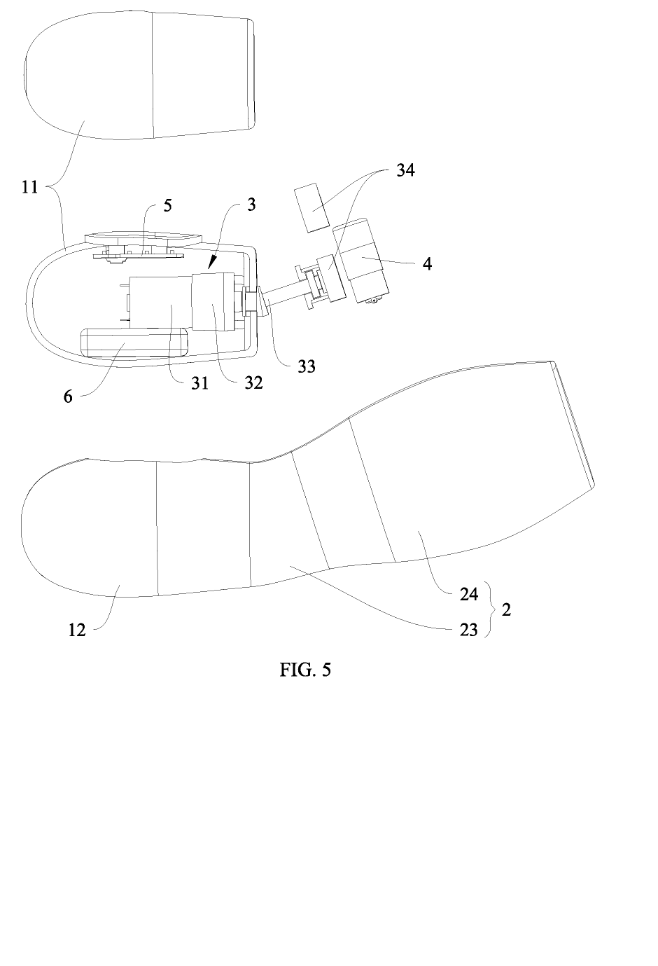

In one embodiment, please refer to FIGS. 4-5, an outer peripheral wall of the first shaft segment 331 is provided with a first mounting groove 333 that is recessed radially inward. The annular flange of the first mounting hole 13 defined by the housing 11 is embedded within the first mounting groove 333, thereby forming an engagement that provides axial constraint and allows rotational movement about the axis. In other embodiments, this engagement can also be achieved by interchanging the arrangement of the flange and the groove. For example, the first shaft segment 331 may be provided with a radially outward protruding flange, while the circumferential wall of the first mounting hole 13 is correspondingly provided with a groove.

Preferably, in some embodiments, please refer to FIGS. 8-9, 12, and 15, the driving assembly 3 includes a bearing 35. The bearing 35 is arranged between the first mounting groove 333 and the first mounting hole 13. The bearing 35 can further reduce frictional resistance between the first shaft segment 331 and the first mounting hole 13, improving the service life of the components and motion stability.

In some embodiments, please refer to FIGS. 4-5, 8-9, 12, and 15, the support member 34 includes a second mounting hole 341. An end of the second shaft segment 332 away from the first shaft segment 331 passes through the second mounting hole 341. The second shaft segment 332 and the second mounting hole 341 are rotatably engaged about the extending axis of the second shaft segment 332 and are fixedly engaged in a direction along the extending axis of the second shaft segment 332. Similarly, the second shaft segment 332 can rotate about its extending axis relative to the support member 34, and the second mounting hole 341 can provide an axial limiting function for the second shaft segment 332, preventing it from accidentally disengaging axially during rotation.

In the aforementioned embodiments, a circumferential wall of the second mounting hole 341 is provided with a second mounting groove 342 that is recessed radially inward. An outer peripheral wall of the second shaft segment 332 is provided with a flange 334, which protrudes radially outward. The flange 334 is rotatably disposed within the second mounting groove 342, thereby forming an engagement that provides axial constraint and allows rotational movement about the axis. In other embodiments, similar to the engagement between the first mounting hole 13 and the first mounting groove 333, the engagement between the second mounting hole 341 and the second mounting groove 342 can also be achieved by interchanging the arrangement of the flange and the groove.

In some embodiments, the penile stimulation device 100 further includes a vibration member 4 disposed within the massage portion 2. It can generate high-frequency vibration for the penis and provide stronger stimulation. The vibration member 4 is or includes a vibration motor. In the embodiments shown in FIGS. 4 and 8, the vibration member 4 is arranged near the bottom wall 212 of the cylindrical cavity. Preferably, the vibration member 4 is arranged in the center part of the closed end 242 of the massage body 24. In the embodiment shown in FIG. 8, the support member 34 has a pair of tubes extending towards the bottom wall 212 and spaced apart from each other. The vibration member 4 is arranged between the pair of tubes.

In the embodiment shown in FIG. 12, the vibration member 4 may also be arranged in the closed end 242 of the massage body 24, specifically positioned near the circumferential wall 211 of the cylindrical cavity. Preferably, the vibration member 4 is located in the part of the massage sleeve 243 that is provided with the ribs 26. Of course, one or more vibration members 4 can also be arranged at any position within the massage portion 2 as needed.

In some embodiments, please refer to FIGS. 4-5, 8-9, 12, and 15, the penile stimulation device 100 further includes a circuit board 5 for implementing electrical control functions. In the illustrated embodiments, the circuit board 5 is received within the housing 11 and is electrically connected to the motor 31 and the vibration member 4. For example, the mounting portion 1 may be provided with a control button, by which the circuit board 5 can be used to control the motor 31, such as start/stop, rotation direction, and rotation speed, etc, as well as control the vibration member 4 such as start/stop, vibration frequency and the like.

In some embodiments, please refer to FIGS. 4-5, 8-9, 12, and 15. The penile stimulation device 100 further includes an energy storage member 6 for providing the electrical power required for the operation of various electrical components of the penile stimulation device 100. Preferably, the energy storage member 6 is a battery. The battery is received within the mounting portion 1 and can be electrically connected to at least one of the circuit board 5 and the motor 31. In the illustrated embodiments, the battery is a rechargeable battery fixedly installed within the housing 11. In other embodiments, the battery may also be a detachable battery for easy replacement.

Finally, it should be noted that: the above merely describes preferred embodiments of the present disclosure without intention to limit the scope of the present disclosure. Although the present disclosure has been described in detail with reference to the foregoing embodiments, for those skilled in the art, the technical solutions described in the foregoing embodiments can still be modified, or some of the technical features can be equally replaced. Any modifications, equivalent replacements, improvements, etc. made within the spirit and principle of the present disclosure should be within the scope of the present disclosure.

What is claimed is:

1. A penile stimulation device, comprising:
a mounting portion, comprising a rigid housing, the rigid housing defining a mounting chamber, the mounting portion having a first end and a second end opposite to the first end along a first axis;
a massage portion, made of a soft material, extending obliquely relative to the first axis, the massage portion having a connecting end movably connected to the first end of the mounting portion and an open end having an opening facing away from the mounting portion, the massage portion defining a massage space in communication with the opening for accommodating a penis; and
a driving assembly, comprising a motor and a gearbox received within the mounting chamber of the rigid housing of the mounting portion; and
wherein the motor is configured to drive the massage portion to rotate around the first axis via the gearbox.

2. The penile stimulation device according to claim 1, wherein the connecting end of the massage portion is fixedly connected to the rigid housing.

3. The penile stimulation device according to claim 1, wherein the massage portion is a first soft member, the mounting portion comprises a second soft member covering an exterior of the rigid housing, and the first soft member is connected to the second soft member.

4. The penile stimulation device according to claim 3, wherein the first soft member and the second soft member are integrally formed as a one-piece structure.

5. The penile stimulation device according to claim 1, wherein the massage portion comprises a connecting sleeve that defines the connecting end and a massage body that defines the open end, the massage body is cylindrical and defines the massage space therein, an end of the connecting sleeve away from the connecting end is connected to an end of the massage body away from the open end, and a wall thickness of the connecting sleeve is less than a wall thickness of the massage body.

6. The penile stimulation device according to claim 5, wherein the connecting sleeve is narrowed and configured as a waist, and a radial dimension of the connecting sleeve is smaller than a radial dimension of the mounting portion and is smaller than a radial dimension of the massage body.

7. The penile stimulation device according to claim 5, wherein the massage body comprises a massage sleeve and a plurality of ribs, the massage sleeve defines the massage space and the opening, the plurality of ribs are arranged spaced apart from each other along a circumferential wall of the massage sleeve, and each of the plurality of ribs extends along an extending direction of the massage sleeve.

8. The penile stimulation device according to claim 7, wherein the plurality of ribs protrude from at least one of an inner surface and an outer surface of the circumferential wall of the massage sleeve.

9. The penile stimulation device according to claim 7, wherein each of the plurality of ribs extends beyond the massage sleeve from an end of the massage sleeve at which the opening is defined to form a free end, and wherein the free ends of the plurality of ribs are arranged in a configuration of claw.

10. The penile stimulation device according to claim 1, wherein the massage space is substantially a cylindrical cavity having a second axis, and a maximum radial dimension of the cylindrical cavity is less than 60 mm.

11. The penile stimulation device according to claim 1, wherein the massage space is substantially a cylindrical cavity having a second axis, and a length of the cylindrical cavity along the second axis is in a range of 20 mm to 120 mm.

12. The penile stimulation device according to claim 1, wherein the massage space is substantially a cylindrical cavity having a second axis, and an inclination angle of the second axis of the cylindrical cavity relative to the first axis is in a range of 5° to 45°.

13. The penile stimulation device according to claim 1, wherein a surface of the massage portion defining the massage space is provided with a plurality of granular bumps.

14. The penile stimulation device according to claim 1, wherein the driving assembly comprises a transmission shaft, one end of the transmission shaft is connected to an output shaft of the gearbox, an other end of the transmission shaft extends into the massage portion and is in transmission connection with the massage portion, and at least a portion of the transmission shaft is inclined relative to the first axis.

15. The penile stimulation device according to claim 14, wherein the driving assembly comprises a support member arranged within the massage portion, and an end of the transmission shaft away from the gearbox is rotatably engaged with the support member.

16. The penile stimulation device according to claim 15, wherein the transmission shaft comprises a first shaft segment and a second shaft segment connected to the first shaft segment, the first shaft segment extends along the first axis, the second shaft segment is inclined relative to the first axis, an end of the first shaft segment away from the second shaft segment is connected to the output shaft of the gearbox, and an end of the second shaft segment away from the first shaft segment is rotatably connected to the support member.

17. The penile stimulation device according to claim 16, wherein the mounting portion is provided with a first mounting hole, the first shaft segment passes through the first mounting hole, the first shaft segment and the first mounting hole are rotatably engaged about the first axis and are fixedly engaged in a direction along the first axis.

18. The penile stimulation device according to claim 17, wherein the driving assembly comprises a bearing, an outer peripheral wall of the first shaft segment is provided with a first mounting groove, and the bearing is arranged between the first mounting groove and the first mounting hole.

19. The penile stimulation device according to claim 16, wherein the support member comprises a second mounting hole, the second shaft segment passes through the second mounting hole, the second shaft segment and the second mounting hole are rotatably engaged about an extending axis of the second shaft segment and are fixedly engaged in a direction along the extending axis of the second shaft segment;
wherein the second mounting hole is provided with a second mounting groove, an outer peripheral wall of the second shaft segment is provided with a flange, and the flange is engaged within the second mounting groove.

20. A penile stimulation device, comprising:
a mounting portion, comprising a rigid housing, the rigid housing defining a mounting chamber, the mounting portion having a first end and a second end opposite to the first end along a first axis;
a massage portion, made of a soft material, having a connecting end movably connected to the first end of the mounting portion and an open end having an opening, the massage portion defining a massage space in communication with the opening for receiving a penis, and the massage space having a second axis extending obliquely relative to the first axis; and
a driving assembly, comprising a motor and a gearbox received within the mounting chamber of the rigid housing of the mounting portion; and
wherein the motor is configured to drive the massage portion to rotate around the first axis via the gearbox.
